(19) United States
(12) Patent Application Publication
(10) Pub. No.: US 2019/0134879 A1
(43) Pub. Date: May 9, 2019

(54) MACHINE FOR HEATING PARISONS WITH TRAVELING TOP RADIATOR

(71) Applicant: KRONES AG, Neutraubling (DE)

(72) Inventor: Wolfgang Schoenberger, Brennberg (DE)

(73) Assignee: KRONES AG, Neutraubling (DE)

(21) Appl. No.: 16/301,268

(22) PCT Filed: Aug. 9, 2017
(86) PCT No.: PCT/EP2017/070254

§ 371 Date: Nov. 13, 2018

(30) Foreign Application Priority Data
Aug. 9, 2016 (DE) 10 2016 114 739.7

(51) Int. Cl. B29C 49/68; B29C 49/64; B29C 49/42; B29C 49/78

(52) U.S. Cl. CPC B29C 49/68; B29C 49/6418; B29C 49/4205; B29C 49/78; B29C 2949/78974; B29C 2949/78462; B29C 2949/78386; B29C 2949/78663; B29C 2949/78899; B29C 2949/7805

(57) ABSTRACT

Provided is a machine for heating plastic parisons, including a transport device which transports the plastic parisons along a predetermined transport path, a heating device which heats the plastic parisons at least intermittently, wherein the heating device includes at least: a bottom heating element which is suitable and intended for heating a bottom portion of the plastic parisons; a reflector element which is installed below the bottom portion of the plastic parisons in the longitudinal direction of the plastic parisons and reflects thermal radiation onto the plastic parisons; an adjusting device which is suitable and intended for adjusting the reflector element in the longitudinal direction of the plastic parisons; and wherein the bottom heating element is arranged on the reflector element and/or is adjustable jointly therewith.

### CROSS-REFERENCE TO RELATED APPLICATIONS

This application claims priority to PCT Application No. PCT/EP2017/070254, having a filing date of Aug. 9, 2017, based on German Application No. 10 2016 114 739.7, having a filing date of Aug. 9, 2016, the entire contents both of which are hereby incorporated by reference.

### FIELD OF TECHNOLOGY

The following relates to a machine and a method for heating plastic parisons. Such machines and methods have been known for a long time from the known art. In the beverage production industry, it is conventional that plastic parisons are transformed into plastic containers, for example by means of blow molding machines. For this purpose, the plastic parisons are first heated in an oven and then delivered in this heated and therefore soft state to the respective blow molding machine. In this case within the context of this heating it is possible that the plastic parisons are transported along a predetermined transport path and in this case are heated by heating devices.

### BACKGROUND

Machines for heating plastic parisons which have a heating element for heating the base portion of the plastic parisons are known from the known art. So-called top radiators are used as heating elements according to the known art. These are installed fixedly and in specific positions and can only be changed manually within a small height range.

It is likewise known to install a bottom reflector below the plastic parison to be heated, which reflects the thermal radiation onto the plastic parison. Moreover, for example, it is known from EP 2 561 972 B1 that this bottom reflector can be configured to be adjustable. Such adjustment enables adaptation to plastic parisons of different lengths and, as a result, an improvement in the energy efficiency.

However, the manual adjustment of the top radiator is elaborate and time-consuming and therefore, according to the known art, is not set as a function of the respective length of the plastic parisons, or the radiator is not inserted and removed. This results in deterioration of the heating profile as well as a deterioration of the energy efficiency. This effect occurs in particular in the case of short plastic parisons.

Moreover, when a permanently installed top radiator is used, adjustment of the bottom reflector is no longer possible, since there is a danger of a collision. This lack of adjustability of the bottom reflector likewise contributes to a deterioration of the heating profile as well as a deterioration of the energy efficiency.

### SUMMARY

An aspect relates to a machine and a method which enable more energy-efficient heating of the plastic parisons, in particular in the bottom region.

A machine according to embodiments of the invention for heating plastic parisons has a transport device which transports the plastic parisons along a predetermined transport path, and a heating device which heats the plastic parisons at least intermittently. The heating device has at least one bottom heating element which is suitable and intended for heating a bottom portion of the plastic parisons, a reflector element which is installed in the longitudinal direction of the plastic parisons below the bottom portion of the plastic parisons and reflects thermal radiation onto the plastic parisons, and an adjustment device which is suitable and intended for adjustment of the reflector element in the longitudinal direction of the plastic parisons.

According to embodiments of the invention the bottom heating element is arranged on the reflector element and/or is adjustable jointly therewith. It is pointed out that the arrangement of the reflector element below the bottom portion occurs in the case in which the plastic parisons are transported with their mouth upwards. However, machines are also known in which the plastic parisons are transported with their mouth downwards. In these cases, the reflector element is arranged above the bottom portion. In general, the reflector element is preferably arranged in a longitudinal direction of the plastic parisons alongside the plastic parisons, but nearer to the bottom portion than to the mouth thereof.

In this case the bottom heating element is preferably configured as a radiation element, particularly preferably as a so-called top radiator, as is known according to the known art for warming the plastic parisons.

The transport device is preferably suitable and intended for transporting the plastic parisons individually. In addition, the transport device is preferably a revolving transport device. In this case this transport device can have a revolving chain on which a plurality of holding devices for holding the plastic parisons are arranged. In this case these holding means can be configured as holding mandrels, which are suitable and intended for engaging in the mouths of the plastic parisons in order to hold them.

In a further advantageous embodiment, the machine also has rotation devices which are suitable and intended for rotating the plastic parisons around the longitudinal directions thereof. The heating element is preferably a heat radiator and particularly preferably an infrared heat radiator.

The bottom heating element is preferably adjusted by the same adjusting device, which is suitable and intended for adjusting the reflector element in the longitudinal direction of the plastic parisons. In particular, this adjustment device has a drive. The drive may be a hand crank, an electric motor or another drive such as for instance a hydraulic or pneumatic drive. The adjustment device preferably enables an adjustment of at least the reflector element in the longitudinal direction of the plastic parisons.

Particularly preferably the reflector element is designed to be movable automatically. In this case in particular it is also conceivable that the machine has a bottom reflector detection device and a parison length detection device. In this case the bottom reflector detection device can preferably detect the position and in particular the height of the reflector element. The parison length detection device for detecting the length of the plastic parisons is advantageously arranged upstream of a first reflector element in the transport direction. The machine advantageously also has a control device which can receive a detection signal from the bottom reflector detection device and the parison length detection device. The control device preferably controls the adjustment device as a function of these received signals.

The bottom heating element is advantageously integrated into the automatically movable reflector element. In particular the bottom heating element can be arranged with a defined spacing on the reflector element or recessed with a defined depth into the reflector element. In this case it would be conceivable that the spacing between the bottom heating element and the reflector element is adjustable. However, in this embodiment the spacing between the bottom heating element and the reflector element can also be clearly defined. In this way the optimal spacing of the reflector element or of the bottom heating element from the bottom portion of the plastic parison can be set, in order to minimise the energy consumed even in the case of plastic parisons of different lengths.

In an advantageous embodiment the heating device has further heating elements which are preferably arranged one above the other in the longitudinal direction of the plastic parisons. These further heating elements preferably heat the entire plastic parison as uniformly as possible in the longitudinal direction. Advantageously the further heating elements can be operated separately from one another. In this way the region heated by the heating elements can be optimally adapted to the plastic parison. In particular as a result it is possible—in particular in the case of short plastic parisons—to prevent a region outside the plastic parison from being irradiated and thus heated. On the one hand this prevents overheating of the heating device and on the other hand enables a particularly energy-saving operation of the machine.

In order to implement a common vertical adjustment of the bottom heating element and of the reflector element, the electrical contacting of the bottom heating element is preferably separated from the actual radiator support, in particular a heater box, and is configured as a separate supply or contact. The electrical contact of the further heating elements is preferably implemented by means of the actual radiator support. The electrical contact of the bottom heating element is advantageously located below a bottom element such as in particular, but not exclusively, a bottom tile, in order to restrict the thermal stress on these components. In particular, the electrical contact is located below the reflector element and/or the bottom heating element. The cable guide is preferably also laid below the reflector element. Advantageously this cable guide is configured to be at least partially flexible.

In a further advantageous embodiment, the machine has further reflector elements which likewise reflect thermal radiation onto the plastic parisons. This may in particular be such radiation which optionally does not initially reach the plastic parisons, but then is deflected onto the plastic parisons by the said reflection. In particular it would be conceivable that the machine has side reflectors which are arranged on the opposite side of the further heating elements with respect to the plastic parisons, and/or side reflectors which are arranged behind the further heating elements with respect to the plastic parisons.

In an advantageous embodiment the thermal radiation is reflected by the reflector element in particular onto the bottom portion of the plastic parisons.

All reflector elements can be polished or mirrored plates, in particular made of aluminium which reflect radiation directly, and/or ceramic reflectors which absorb the radiation and then transmit it again as heat.

Preferably the machine can be used both passively, with the bottom heating element switched off, and also actively, with the bottom heating element switched on.

The thermal radiation of the heating device is advantageously infrared radiation. The further heating elements can be in particular infrared tubes. These infrared tubes advantageously extend in the direction of the transport path of the plastic parisons and in particular in a rectilinear direction.

In an advantageous embodiment a plurality of individual heating modules can be provided along the transport path of the plastic parisons. In this case a bottom heating element and further heating elements are preferably arranged inside each heating module. Advantageously each heating module can be regulated separately.

The object of embodiments of the present invention is likewise achieved by a machine for heating plastic parisons with a transport device which transports the plastic parisons along a predetermined transport path, with a heating device which heats the plastic parisons at least intermittently, wherein the heating device comprises at least one reflector element which is installed in the longitudinal direction of the plastic parisons below the bottom portion of the plastic parisons and reflects thermal radiation onto the plastic parisons, an adjustment device which is suitable and intended for adjustment of the reflector element in the longitudinal direction of the plastic parisons, and at least one heating element and preferably a plurality of heating elements which are preferably arranged one above the other in the longitudinal direction of the plastic parisons. In relation to the transport path of the plastic parisons, preferably the heating element is arranged, and particularly preferably the heating elements are arranged, at the side of the transport path.

According to embodiments of the invention the machine has a control device which is suitable and intended in order, as a function of the position of the reflector element, preferably with respect to the longitudinal direction of the plastic parisons, to switch on at least one heating element automatically and/or to switch it off automatically and/or preferably automatically to block switching on of at least one heating element and/or to allow switching on of at least one heating element. In this case the machine can be provided with all features in connection with the machine described above individually or in combination and vice versa. Such a proposed automatic switching on and/or switching off offers the advantage that faulty operation of the heating elements (by an operator) can be ruled out and thus a destruction of the heating elements and/or base elements or tiles, as well as a risk of fire in the event that switched-on heating elements are located below the reflector element, can be ruled out. Therefore, such an arrangement of switched-on heating elements below a reflector element can be so dangerous because any electrical power supply lines can be arranged below the reflector element. In particular, with an arrangement of bottom heating elements on movable or adjustable reflector elements it has proved advantageous to wire the electrical connection of the bottom heating elements directly to the heating controller. Preferably in each case two contactors which switch off for safety purposes ensure the electrical isolation of the bottom heating elements from the heating controller as soon as the protection region is opened.

A switching off of a heating element is preferably understood to mean not only the transfer of the heating element from a heating mode or state of the heating element (i.e. in which the heating power is not zero) to a non-heating state, in which preferably the heating element is isolated from its current source or power source or in which the heating power of the heating element is zero, but also a transfer to a deactivated state, in which the heating element preferably cannot be switched on (by an operator or without prior clearance). A switching on of a heating element is preferably understood to mean not only the “actual switching on”, i.e. the setting of the heating element to a heating operational state (in which the heating power of the heating element has a predetermined value different from zero), but the switching on of a heating element can also be understood to be the clearance of a state in which a heating element cannot be activated or is immobilised or cannot be switched on or cannot be transferred (by an operator) into a state in which it can be heated (i.e. an activatable state). However, it is also conceivable that the control device preferably only checks whether (at least) one heating element or preferably a plurality of heating elements are in a heating state and, depending upon the position of the reflector element, automatically performs an “actual switching off”, i.e. the transfer into a non-heating state, and/or an “actual switching on”, i.e. the transfer into a heating state.

The machine preferably has, in relation to the transport path of the plastic parisons, at least one further bottom element which is located behind (downstream by comparison with) the (first) bottom element and can be moved by an adjustment device in relation to the longitudinal direction of the plastic parisons. The machine preferably has at least one further heating element and preferably further heating elements which, in relation to the transport path of the plastic parisons, are arranged behind (downstream by comparison with) the at least one heating element, and in relation to the transport path of the plastic parisons are preferably arranged laterally alongside the transport path, and are arranged one above the other at least partially in relation to the longitudinal direction of the plastic parisons. In this case a plurality of heating elements, which are preferably arranged one above the other in relation to the longitudinal direction of the plastic parisons, can be arranged jointly in a so-called heater box. The following is described below merely in relation to a reflector element or in relation to a bottom heating element or in relation to a heater box. However, it is self-evident that the individually described features or combinations thereof can likewise be transferred to further reflector elements or bottom heating elements or further heater boxes.

In an advantageous embodiment the control device is suitable and intended to automatically switch on and/or switch off at least one heating element and preferably all heating elements which is/are arranged below the reflector element (or the current position of the reflector element) in relation to the longitudinal direction of the plastic parisons. It is also conceivable that a safety distance is predetermined and the control device checks whether this predetermined safety distance is provided between the position of the reflector element and at least one heating element and preferably for each heating element, and in the event that a heating element does not comply with this safety distance the corresponding heating element is switched off. Thus, it is proposed that a possible switching on of heating elements or lamps (of a heater box) which are located below the top radiator or the bottom element is prevented or heating elements which are already switched on are switched off.

In an advantageous embodiment the heating device has at least one bottom heating element which is preferably arranged on the reflector element and which is suitable and intended to heat a bottom portion of the plastic parisons, wherein the control device is suitable and intended to automatically switch on and/or switch off at least one heating element as a function of the position of the bottom heating element with respect to the longitudinal direction of the plastic parisons. The control device is preferably suitable and intended to automatically switch on and/or switch off at least one heating element and preferably all heating elements which is/are arranged below the bottom heating element (or the current position of the bottom heating element) in relation to the longitudinal direction of the plastic parisons. Likewise, it is also conceivable that a safety distance is predetermined and the control device checks whether this predetermined safety distance is provided between the position of the bottom heating element and at least one heating element and preferably for each heating element, and in the event that a heating element does not comply with this safety distance the corresponding heating element is switched off.

In a further advantageous embodiment, the control device automatically switches at least one heating element on and/or off in response to a signal transmitted by the adjustment device, which preferably contains information about a current position and/or a planned position of the reflector element and/or of the bottom heating element.

In a further advantageous embodiment, the machine has a sensor device for detecting a position of the reflector element and/or a position of the bottom heating element, wherein the control device automatically switches at least one heating element on and/or off as a function of a position detected by the sensor device.

In a further advantageous embodiment, the control device is suitable and intended to automatically switch a heating element on and/or off as a function of the (longitudinal) extent of the plastic parisons with respect to the longitudinal direction of the plastic parisons. Preferably, as a function of the (longitudinal) extent of the plastic parison, the control device immediately switches off all the heating elements arranged at a height in relation to the longitudinal direction of the plastic parisons. The prescribed target position (as a function of the length the plastic parisons) of the assembly of the movable bottom tiles is preferably used in order to determine the relevant heating elements or lamps (to be switched off and/or on). In connection with the lamp spacings or spacings of the heating elements input into the mechanical setting values it is then possible to calculate which lamp zones or which heating elements are arranged below or above a bottom heating element and/or a reflector element.

The machine, in particular the heating device, can preferably be switched on only when the reflector elements or the bottom tiles have reached their (predetermined) target position.

In a further advantageous embodiment, as a function of the position of the reflector element with respect to the longitudinal direction of the plastic parisons and/or as a function of the position of a bottom heating element with respect to the longitudinal direction of the plastic parisons, the control device blocks switching on of at least one heating element and/or allows a switching on which has been blocked. This offers the advantage that an undesirable manual intervention by an operator can be prevented.

The control device is preferably suitable and intended, using an operating device for operating the machine, in particular the heating device, to activate and/or to deactivate switching on and off of a heating element and preferably of all heating elements, as a function of the position of the reflector element (or the reflector elements) with respect to the longitudinal direction of the plastic parisons and/or as a function of the position of a bottom heating element with respect to the longitudinal direction of the plastic parisons. Preferably, a switched-on and/or switched-off state, and/or an activated and/or deactivated state in which preferably no switching off or on by a user is possible, of a heating element or the heating elements can be output (visually) on a (visual) display device. This can take place in the operating device for instance by greying out these heating elements or lamps, for instance in a lamp matrix of the user interface, so that preferably they can no longer be switched on. Furthermore, possible switching on is preferably prevented in that the lamps or the heating elements are monitored in the controller and are actively switched off, if for instance one of these dangerous heating elements or lamps should nevertheless be switched on, for example after a recipe change with different plastic parison lengths and, as a result, different positions of the reflector elements or the bottom tiles. Additionally, the heating power or the zone power of the heating elements or the lamps below the reflector element or the bottom tile is preferably set to 0%.

The bottom heating element or the bottom heating elements can preferably be used independently of the position of the reflector element or the reflector elements or they can be switched on and/or switched off. Preferably in an operating device and/or the display device the position of a bottom heating element, preferably of all the bottom heating elements (relative to the transport path of the plastic parisons and/or also relative to the longitudinal direction of the plastic parisons), is preferably marked or displayed for example in the lamp matrix, for instance by marking with a “T” in the lamp matrix.

Furthermore, embodiments of the present invention are directed to a method for heating plastic parisons, wherein the plastic parisons are transported by a transport device along a predetermined transport path and are heated at least intermittently by a heating device. In this case the bottom portion of the plastic parisons is at least also heated by a bottom heating element. A reflector element which is installed in the longitudinal direction of the plastic parisons below the bottom portion of the plastic parisons and reflects thermal radiation onto the plastic parisons. This reflector element can be adjusted in longitudinal direction of the plastic parisons by an adjustment device.

According to embodiments of the invention the bottom heating element is arranged on the reflector element and/or is adjustable jointly therewith.

In this case the machine described above is in particular configured and provided in order to carry out this method, i.e. all the features set out for the machine described above are likewise disclosed for the method described here, and vice versa.

The bottom heating element is advantageously adjusted jointly with the reflector element as a function of the length of the plastic parison to be heated. This leads to a better energy input into the preform tip, since in this way the bottom heating element and the reflector element can be placed nearby, quickly and without complications, in relation to the respective different lengths of the plastic parisons.

The plastic parisons are preferably heated by further heating elements which are preferably arranged one above the other in the longitudinal direction of the plastic parisons.

In an advantageous embodiment these further heating elements and the bottom heating element are supplied with current separately from one another.

Furthermore, embodiments of the present invention are directed to a method for heating plastic parisons, wherein the plastic parisons are transported by a transport device along a predetermined transport path and are heated at least intermittently by a heating device. A reflector element, which is installed in the longitudinal direction of the plastic parisons below the bottom portion of the plastic parisons, reflects thermal radiation onto the plastic parisons. This reflector element can be adjusted in the longitudinal direction of the plastic parisons by an adjustment device.

According to embodiments of the invention at least one heating element is automatically switched on and/or switched off and/or activated and/or deactivated as a function of the position of the reflector element relative to the longitudinal direction of the plastic parisons. In this case the machine described above is in particular configured and provided in order to carry out this method, i.e. all the features set out for the machine described above are likewise disclosed for the method described here, and vice versa. Likewise, the method can be provided with all features in connection with the method described above individually or in combination and vice versa.

Preferably in this case the bottom portion of the plastic parisons is at least also heated by a bottom heating element, and particularly preferably at least one heating element is automatically switched on and/or switched off and/or activated and/or deactivated as a function of the position of the bottom heating element relative to the longitudinal direction of the plastic parisons.

### BRIEF DESCRIPTION

Some of the embodiments will be described in detail, with references to the following Figures, wherein like designations denote like members, wherein:

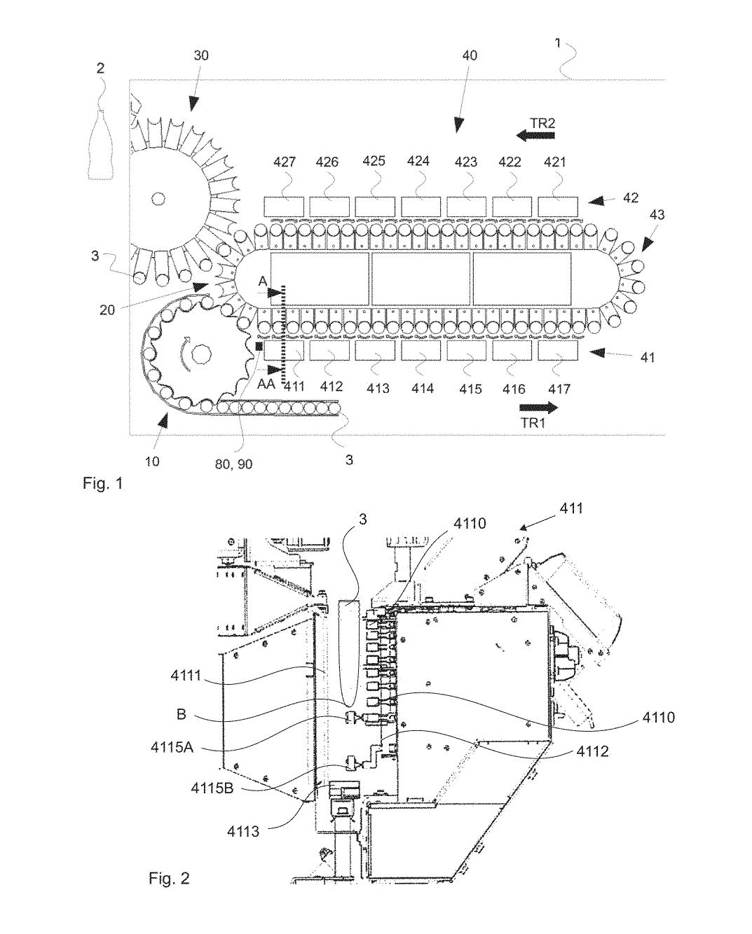

FIG. 1 shows a schematic top view of a part of a blow molding machine;

FIG. 2 shows a schematic partial view of a machine according to the known art;

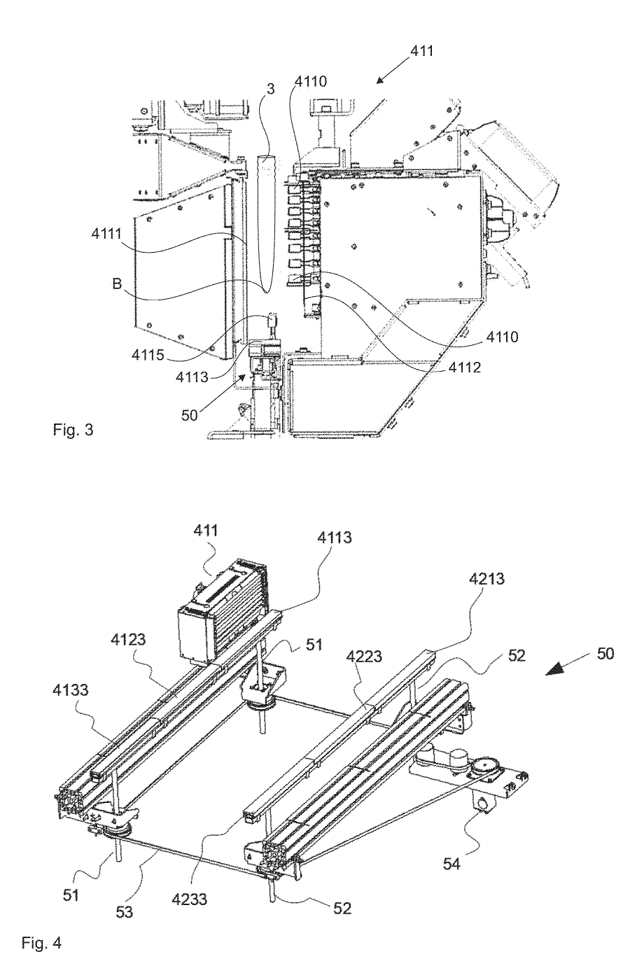

FIG. 3 shows a schematic partial view of a machine with an adjustable bottom heating element;

FIG. 4 shows a perspective view of an adjustment device;

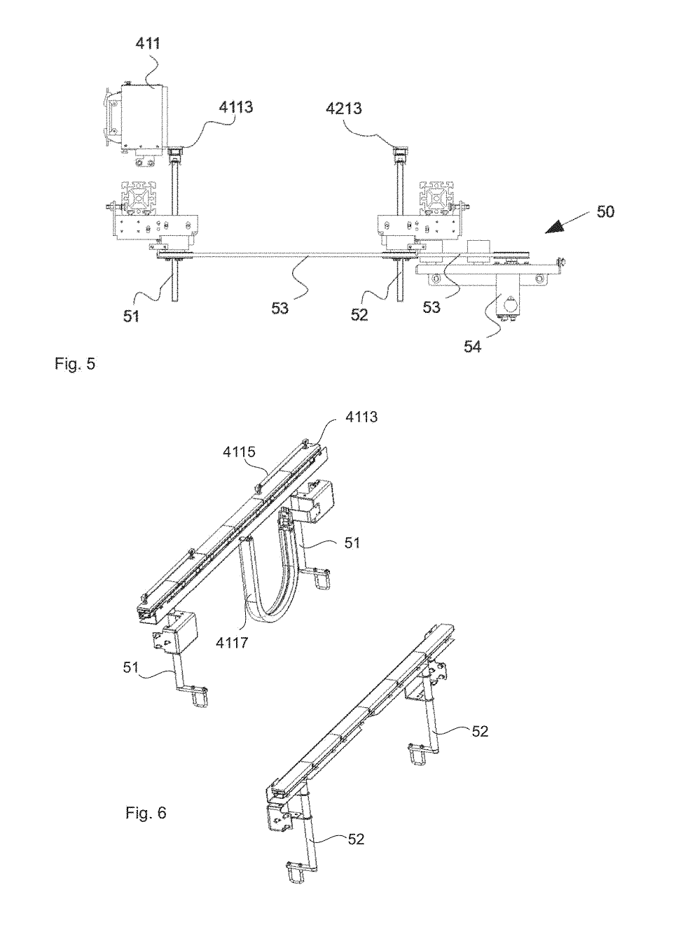

FIG. 5 shows a sectional view of the adjustment device;

FIG. 6 shows a perspective view of the adjustment device and current supply of the bottom heating element;

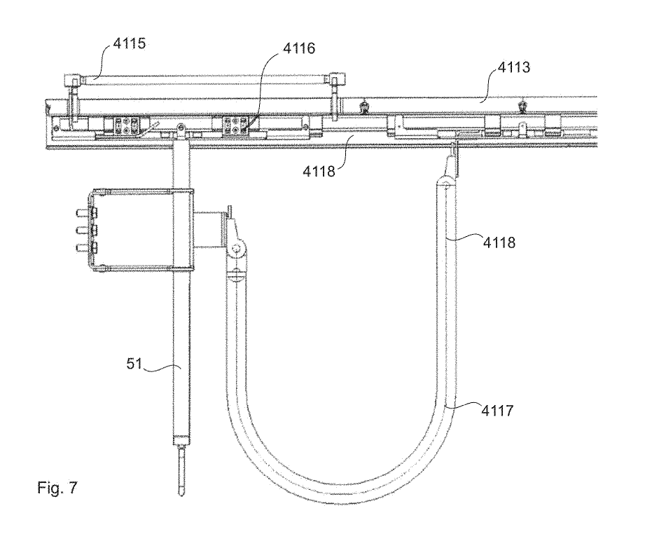

FIG. 7 shows a sectional view of the adjustment device and current supply of the bottom heating element;

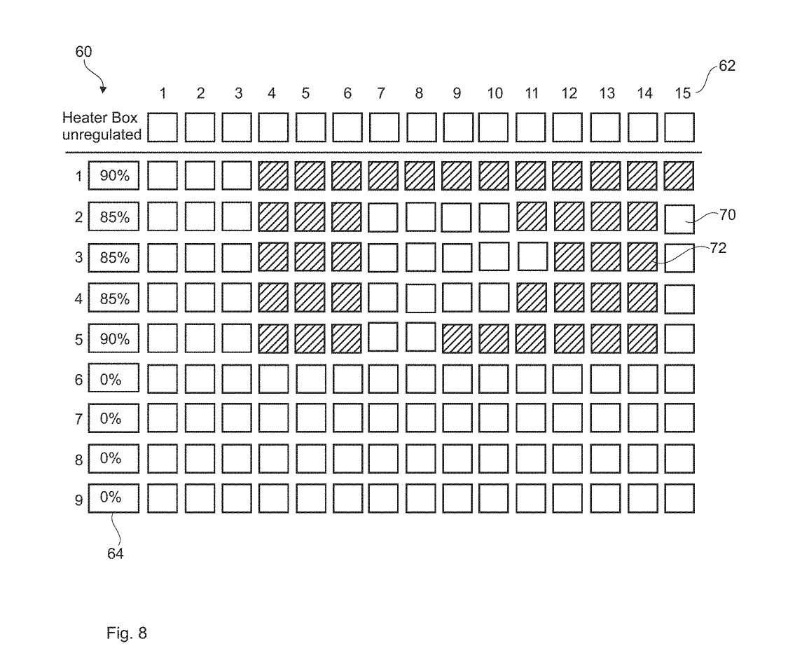

FIG. 8 shows a representation of an operating device;

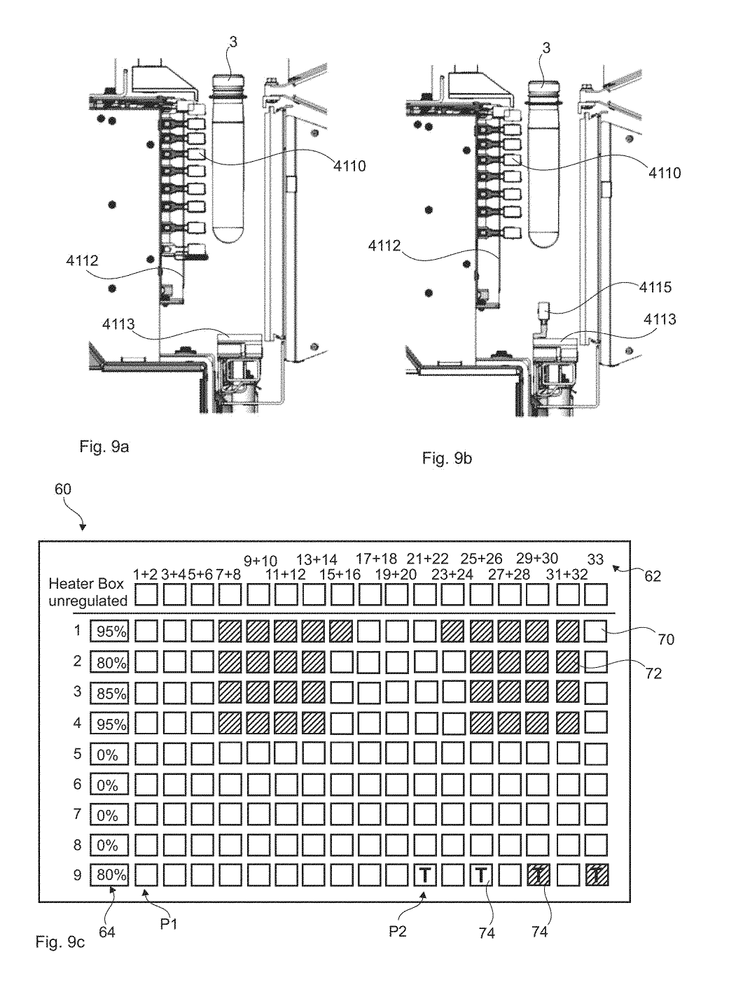

FIG. 9a shows a first representation of a machine with an adjustable reflector element in a lowest state;

FIG. 9b shows a second representation of a machine with an adjustable reflector element in a lowest state;

FIG. 9c shows a representation of a method according to embodiments of the invention;

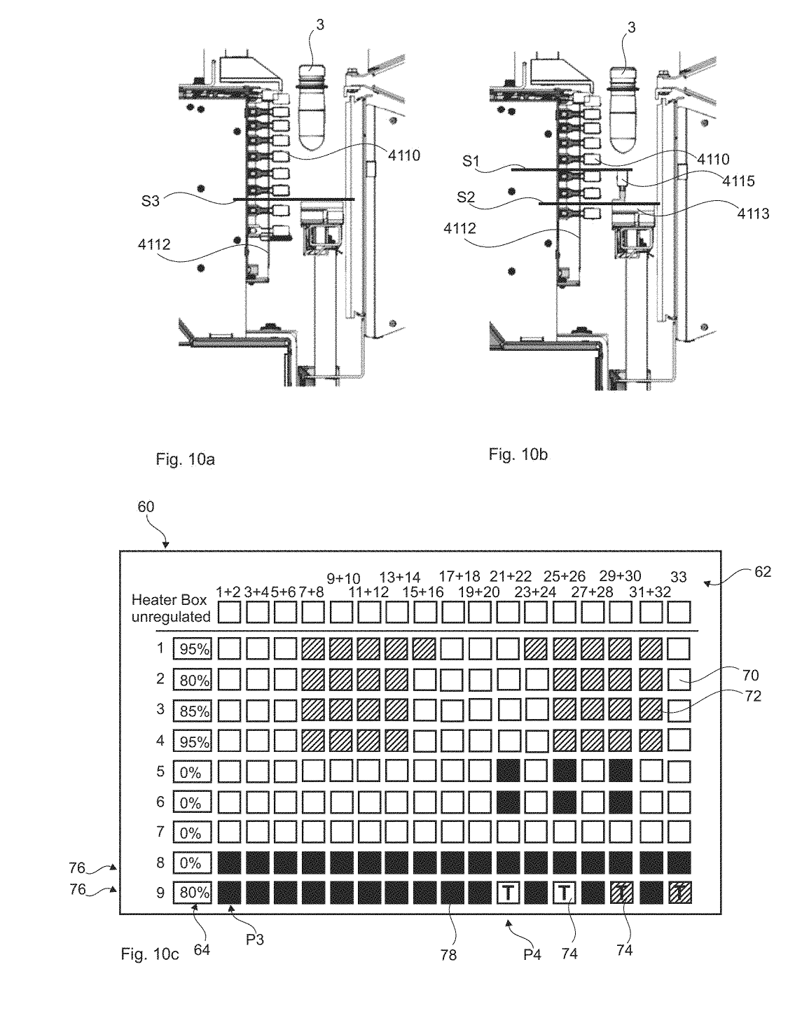

FIG. 10a shows a first representation of a machine with an adjustable reflector element in a raised state;

FIG. 10b shows a second representation of a machine with an adjustable reflector element in a raised state; and

FIG. 10c shows a representation of a method according to embodiments of the invention.

### DETAILED DESCRIPTION

FIG. 1 shows a part of a blow molding machine 1 for manufacturing containers 2 from parisons 3 made of plastic, such as polyethylene terephthalate (PET), polypropylene (PP) etc., in which the machine according to embodiments of the invention can be used. The finished containers 2 can be for example bottles, such as are illustrated in FIG. 1, into which a product can be introduced. The product can be in particular a beverage, a cleaning agent etc. The parisons 3 are illustrated in FIG. 1 as circles for their mouths, wherein for the sake of clarity only two of the parisons 3, at the start (in FIG. 1 at the bottom) and at the end (in FIG. 1 on the left) of the row formed by them, are provided with a reference numeral.

The blow molding machine 1 in FIG. 1 comprises a first transport device 10, a second transport device 20, a third transport device 30, a heating device 40 and a blowing device (not illustrated) which is arranged downstream of the third transport device 30. In the blowing device (not illustrated) the parisons 3 heated by the heating device 40 can be blown into the required shape of the bottle 2 by blowing in of a gaseous medium. The blow molding machine 1 can in particular be a stretch blow molding machine. Moreover, in FIG. 1 a bottom reflector detection device 80 and a parison length detection device 90 are shown schematically at the inlet of the heating device 40.

The first, second and third transport devices 10, 20, 30 each serve for transporting the plurality of parisons 3 illustrated in FIG. 1. In this case the parisons 3 are in each case arranged one behind the other in a row in the transport direction of the first to third transport devices 10, 20, 30. In FIG. 1 the first transport device 10 is formed as a sawtooth star wheel which is rotatably mounted, as indicated in FIG. 1 by a rotating arrow on the first transport device 10. The first transport device 10 transfers the parisons 3 held by it to the second transport device 20.

The second transport device 20 is a conveyor line along which a first heating section 41 and a second heating section 42 of the heating device 40 are arranged and between which the heating device 40 has a redirection region 43. The first and second heating section 41, 42 are in each case linear heating sections. In the redirection region 43, in which the parisons 3 are guided along a semicircle, the parisons 3 are redirected from a first transport direction TR1 into a second transport direction TR2. In FIG. 1 the first transport direction TR1, in which the parisons 3 are transported through the first heating section 41, is opposite to the second transport direction TR2, in which the parisons 3 are transported through the second heating section 42.

In the second transport device 20 the parisons 3 are held at their mouth by a spindle which is mounted rotatably in a chain link. A plurality of chain links, with the spindles mounted therein, are connected to one another so that the chain links form a continuously revolving chain and thus form the conveyor line of the second transport device 20. After running through the second heating section 42, the parisons 3 are transferred from the second transport device 20 to the third transport device 30, which is likewise mounted rotatably and the parisons 3 heated by the heating device 40 are transported further to the blowing device (not shown). Thus, the parisons 3 are heated by the heating device 40 while they are transported by means of the second transport device 20 through the heating section 41, 42, as described in greater detail below.

In this case the parisons 3 are rotated about their axis by means of the spindle, as indicated in FIG. 1 by small white rotating block arrows. The first heating section 41 serves for first heating of the parisons 3. In this case the parisons 3 are heated uniformly on the circumference. The first heating section 41 has a plurality of heating modules, specifically a first heating module 411, a second heating module 412, a third heating module 413, a fourth heating module 414, a fifth heating module 415, a sixth heating module 416, and a seventh heating module 417. The heating modules 411 to 417 are arranged one behind the other in this order in the first transport direction TR1.

The number of heating modules 411 to 417 is individually adaptable and depends upon the required heating time or the number of heating elements. The second heating section 42 serves for second heating of the parisons 3. In this case the parisons 3 are heated to the ultimate temperature at which they can be transformed into a container 2 by means of the blowing device (not shown). The ultimate temperature is also designated as the transforming temperature of the parisons 3.

The second heating section 42 likewise has a plurality of heating modules, specifically a first heating module 421, a second heating module 422, a third heating module 423, a fourth heating module 424, a fifth heating module 425, a sixth heating module 426, and a seventh heating module 427. The heating modules 421 to 427 are arranged one behind the other in this order in the second transport direction TR2. In the redirection region 43 no heating of the parisons 3 takes place by means of heating sections or heating modules.

In FIG. 1, for the sake of simplicity, the heating modules 411 to 417 of the first heating section 41 and the heating modules 421 to 427 of the second heating section 42 are shown in each case as arranged externally alongside a conveyor line formed by the second transport device 20.

FIG. 2 shows a section, in the direction of the arrows A/AA along the bold broken line in FIG. 1, through the first heating module 411 of the first heating section 41 according to the embodiment according to the known art. The heating modules 412 to 417 of the first heating section 41 and the heating modules 421 to 427 of the second heating section 42 are formed in each case in the same way as the first heating module 411 of the heating section 41, so that for the structure thereof reference is made to the description of the first heating module 411.

The first heating module 411 has a plurality of heating elements 4110 which are arranged on the right-hand side of the parisons 3 in FIG. 2. The plurality of heating elements 4110 are in a row one above the other. In FIG. 2 for the sake of clarity only the uppermost and lowest heating elements 4110 are provided with a reference numeral. In addition, each heating element 4110 is an elongated radiator, of which the length is arranged in the first transport direction TR1 or extends in the first transport direction TR1. Each heating element 4110 serves for emitting thermal radiation or heat radiation onto den parison 3, which heats the parison 3.

On the left-hand side of the parison 3 a counterpart reflector 4111 is arranged, which extends both in the direction of the length L of the parison 3 (in FIG. 2 the vertical direction) and also in the transport direction TR1. The counterpart reflector 4111 reflects the thermal radiation not absorbed by the parisons 3 back to the parison 3 or the parisons 3 arranged before it and behind it. In addition, on the side of the heating element 4110 a back reflector is provided which likewise reflects the thermal radiation not absorbed by the parisons 3 back to the parison 3 or to the parisons 3 arranged before it and behind it.

Moreover, below the parison 3 a reflector element 4113 is arranged, which likewise reflects the thermal radiation not absorbed by the parisons 3 back to the parison 3 or the parisons 3 arranged before it and behind it.

The reflector element 4113 reflects the thermal radiation in particular in the direction of the bottom portion B of the parisons 3 to be heated. The reflector element 4113 is arranged transversely with respect to the back reflector 4112 and to the counterpart reflector 4111. Here “transversely” means that the arrangement of the reflector element can deviate by up to 10° from the exact transverse direction.

In addition, a bottom heating element 4115 is present, which is arranged between the bottom portion B of the parison 3 and the reflector element 4113. Depending upon the length of the plastic parison, the bottom heating element can be installed for example either at the position 4115A or the position 4115B. According to the known art, when the length of the plastic parisons is changed, this necessitates conversion or a relatively awkward adjustment of the bottom heating element 4115 from the position 4115A to 4115B or vice versa.

FIG. 3 shows the section according to FIG. 2 through the first heating module 411 of the first heating section 41 in the case of a machine according to embodiments of the invention with an adjustable bottom heating element. Here too, the parison is heated by the heating elements 4110. However, in the machine according to embodiments of the invention the bottom heating element 4115 is arranged on the reflector element 4113. The reflector element 4113 can be moved by the adjustment device 50 towards parison 3 or away from it. In this case the bottom heating element 4115 is adjusted jointly with the reflector element 4113 by the adjustment device 50.

In this way the thermal radiation can be used particularly effectively for heating parisons of a different size. Since on the one hand the reflector element 4113 can be moved relatively close to the bottom portion B, it is ensured that hardly any thermal radiation is unused. Moreover, since the spacing between the bottom portion B of the parison 3 and the bottom heating element 4115 can be changed, the bottom portion B can heat in a particularly targeted manner. In this way the spacing between the bottom portion B and the bottom heating element 4115 or the reflector element 4113 can be set optimally with regard to the utilisation of the thermal radiation of the heating element 4110 and 4115.

In the embodiment illustrated in FIG. 3 the bottom heating element 4115 is arranged with a defined spacing on the reflector element 4113. However, an embodiment would also be conceivable in which the bottom heating element 4115 is recessed by a defined depth into the reflector element 4113.

For further energy saving the lower heating elements 4110 can be deactivated during the heating of shorter parisons 3, for example switched off or alternatively moved away and switched off, so that in each case only the heating elements 4110 which are actually required for heating the parisons 3 are used for heating the parisons 3. In other words, the lower heating element 4110 are used only during the heating of a longer parison, whereas they are not used during the heating of a shorter parison.

FIG. 4 and FIG. 5 show an adjustment device 50 of the blow molding machine 1, by which the reflector element 4113 of the heating module 411 and, jointly with it, all other bottom reflector elements of the heating modules 412 to 417 and 421 to 427 can be adjusted in their position, in particular their height. Alternatively, one single, continuous reflector element 4113 can also be provided in each heating section 41. For the sake of simplicity of the representation, FIG. 4 and FIG. 5 only show the heating module 411 of the first heating section 41, its reflector element 4113, the reflector element 4123 of the second heating module 412 of the first heating section 41, the reflector element 4133 of the third heating module 413 of the first heating section 41, the reflector element 4213 of the first heating module 421 of the second heating section 42, the reflector element 4223 of the second heating module 422 of the second heating section 42, and the reflector element 4233 of the third heating module 423 of the second heating section 42. The reflector element 4113, the reflector element 4123 and the reflector element 4133 of the first heating section 41 are supported by two rods 51 which are configured as threaded spindles. The two rods 51 are a first supporting device for supporting the reflector elements 4113, 4123, 4133 of the first heating section 41.

The reflector elements 4213, 4223 and 4233 of the second heating section 42 are supported by two rods 52 which are likewise configured as threaded spindles. The two rods 52 are a second supporting device for supporting the reflector elements 4213, 4223, 4233 of the second heating section 42. By means of a belt 53 laid around them, the rods 51 and 52 or the first and second supporting device 51, 52 are coupled to one another and to a driving device 54. The belt 53 is a coupling device for coupling the first and second supporting device 51, 52 to the driving device 54. Thus driving of the belt 53 by the driving device 54 causes a rotation of the rods 51, 52 about their axis, which results in a joint and synchronised adjustment of all reflector elements of the heating modules of the first and second heating sections 41, 42. Thus the reflector elements of the heating modules of the first and second heating sections 41, 42 can be adjusted centrally. The driving device 54 can be for example an electrical, pneumatic or electromechanical actuating drive device.

The setting of the position of the reflector elements of the heating modules 411 to 417 and 421 to 427 by means of the adjustment device 50 can be performed by an operator using a switch or a push button on a control panel of the heating device 40 or the blow molding machine 1. In other words, the setting of the position of the bottom reflectors takes place automatically by means of the adjustment device 50. This advantageously involves a gradual variable fine adjustment which thus can be optimally adapted to any length of the parisons 3.

As an alternative to this, the reflector elements of the heating modules 411 to 417 and 421 to 427 can be set automatically by the adjustment device 50. In this case the adjustment device 50 is controlled by a control device (not shown) of the blow molding machine 1. For the control of the blow molding machine 1 the control device can for example access the values determined by the bottom reflector detection device 80 and the parison length detection device 90.

FIGS. 6 and 7 likewise show representations of the adjustment device 50. These representations in particular show the current supply of the bottom heating element 4115. For reasons of greater clarity, a repeated representation of the heating module 411 has been omitted.

Unlike an embodiment which only has a reflector element 4113 below the parison 3, in this case a bottom heating element 4115 requires an electrical contact. However, this electrical contact of a bottom heating element 4115 preferably does not take place as in the known art (FIG. 2) jointly with the further heating elements 4110. A disadvantage of the known art illustrated in FIG. 2 is in particular that an adjustment of the bottom heating element 4115 does not take place or can only take place by awkward conversion.

Therefore, the drawings show that the electrical contact 4116 (cf. FIG. 7) of the bottom heating element 4115 is preferably configured separately from the contact of the further heating elements 4110. In order to restrict thermal stress on the corresponding components, the electrical contact 4116 of the bottom heating element 4115 is preferably placed below the reflector element 4113 and below the bottom heating element 4115. Therefore, the electrical cable 4118, which supplies all the bottom heating elements 4115, 4125, 4135 etc. with current, likewise extends below the reflector elements 4113, 4123, 4133 etc. The electrical cable 4118 preferably extends substantially parallel to the plane of the reflector elements 4113, 4123, 4133 etc.

The cable guide 4117 likewise extends below the reflector elements. The cable guide 4117 carries the electrical cable 4118 starting from the adjustment device 50, in particular starting from one of the rods 51, to the underside of the reflector elements, below which the electrical cable 4118 is further guided in parallel. The cable guide 4117 is preferably configured to be at least partially flexible, so that the electrical cable 4118 can be arranged immovably on the adjustment device 50. Nevertheless, the flexibility of the cable guide 4117 makes it possible that, in the event of consistently good electrical contact, the reflector elements and bottom heating elements can be adjusted in height by the adjustment device 50.

FIG. 8 shows a representation of an operating device 60. It will be recognized here that the heating device 40 has a plurality of heater boxes, which are arranged one behind the other along the transport path of the plastic parisons 3, and past which the individual plastic parisons are transported. In this case the reference numeral 62 designates the numbers assigned to the heater boxes. In this case the heater boxes standing adjacent to one another are arranged one behind the other along the transport path of the plastic parisons. In this case each of these heater boxes has a plurality of heating elements 4110, which are arranged one above the other in the longitudinal direction L of the plastic parisons 3. It will be recognized here by means of the status displays of the individual heating elements represented by empty squares 70, that in the heating zones 6-9 or the heating elements 4110 of these heating zones are in each case switched off. In this case cross-hatched squares 72 represent a switched-on state of the respective heating element 4110. In the remaining heating zones 1-5 the respective heating elements of the heating cabinets 62 are in some instances switched on and off. In particular an operational state of the heating elements 4110 shown in FIG. 8 is suitable for shorter plastic parisons, the extent of which along their longitudinal direction L does not extend into the zones 6 to 9. In this case the reference numeral 64 designates details (in percentage terms) about the heating power of the different heating zones or lamp zones. In this case the heating zones are produced by the heating elements (different heater boxes 62) arranged one behind the other in relation to the transport path at the same height with respect to the longitudinal direction of the plastic parisons.

Due to the use of the movable top radiator or of a bottom heating element 4115 which is adjustable (in the longitudinal direction L) the situation can now arise that the top radiator or the bottom heating element 4115 can be positioned in the radiator region of the lamps fastened to the heater box or at least of a heating element 4110 of a heater box. With a correctly set heating profile, preferably no light or no heating element 4110 is activated which can heat the top radiator or the bottom heating element 4115 from the side or below, but this cannot be seen on the user interface 60 of the lamp matrix or the operating device 60. Likewise, lamps of the zones or heating elements of the zones can also be activated below the bottom tiles or below at least one reflector element 4113. Information on the position of the reflector element is missing here and all heating elements 4110 can always be selected. As a result, the operator does not notice if he has switched on a lamp or a heating element 4110 below the top radiator or below the bottom heating element 4115 and/or below the reflector element 4113. If a lamp is switched on below the top radiator or the bottom heating element 4115, its power cable, which is preferably laid along the reflector element or the bottom tile, can overheat and can even catch fire. The switching on of lamps or heating elements 4110 below a reflector element 4113 or the bottom tile hides an even greater potential danger, since here there is no thermal barrier to heat-sensitive components. There is an acute risk of fire.

FIGS. 9a and 9b show two side views of a device, in this case a heater box, with a reflector element 4113 which is adjustable by an adjustment device 50 and which, here, is in each case in a lowest state relative to the longitudinal direction of the plastic parisons. Thus, here the bottom tiles or the reflector elements are moved down completely and all lamps or heating elements 4110 are free, i.e. arranged above the bottom tiles or the reflector element 4113. In this case FIG. 9a shows a device or a heater box without a bottom heating element 4115, whilst in the device or heater box illustrated in FIG. 9b a bottom heating element 4115 is arranged on the reflector element 4113 or a bottom tile. A method according to embodiments of the invention is illustrated by the operating device 60 or display device illustrated in FIG. 9c. Since all heating elements 4110 are arranged above the reflector element 4113, all heating elements 4110 should be used for heating the plastic parisons 3, and thus all heating elements 4110 should be switched on by an operator. This can be seen on the operating device 60 or display device by the exclusive use, as operating elements for the individual heating elements 4110, of symbols 70, 72 which (exclusively) indicate whether the respective heating element 4110 is switched on or switched off. In this case the reference numeral 70 designates a switched-off state of the relevant heating element 4110 and the reference numeral 72 designates a switched-on state of the relevant heating element 4110. In principle, however, the heating power of all heating elements 4110 can be changed by the operator. In addition, in the operating device 60 the symbol “T” designates a position of the top radiator or of the bottom heating elements 4115 in relation to the transport path of the plastic parisons or in relation to the respective heater box 62. The top radiators or the bottom heating elements 4115 can always be used independently of the bottom tile position or the position of the reflector elements 4113.

The arrow P1 now illustrates a possible setting of the heating powers of the heating elements 4110 of a heater box illustrated in FIG. 9a, in which no bottom heating element 4115 is provided, and (currently) also no heating element 4110 is switched on, although all can be switched on. The arrow P2 illustrates a possible setting of the heating powers of the heating elements 4110 of a heater box illustrated in FIG. 9b, in which no bottom heating element 4115 is provided, and this is designated in the operating device 60 or a display device by a symbol 74 “T”, and (currently) also no heating element 4110 is switched on, although all can be switched on.

FIGS. 10a and 10b show two side views of the machine, in particular of a heater box with an adjustable reflector element 4113 which is now to be used for heating of a shorter plastic parison 3 (by comparison for instance with the plastic parisons 3 illustrated in FIGS. 9a and 9b). For this purpose, the reflector element 4113 is located in a raised state (preferably by the adjustment device 50). The reflector element 4113 or the bottom tile is raised here. In this case FIG. 10a again shows a machine or a heater box without a bottom heating element 4115, whilst in the machine or heater box illustrated in FIG. 10b a bottom heating element 4115 is arranged on the reflector element 4113 or on a bottom tile. The method according to embodiments of the invention is illustrated by the operating device 60 or display device shown in FIG. 10c.

The heating element 4110 or lamps of the two lowest heating zones 8 and 9 (see FIG. 10c) are below the reflector element 4113 (compare the position of the lowest two heating elements 4110 in FIG. 10a with the position of the base element 4113 designated by the reference numeral S3 in relation to the longitudinal direction of the plastic parisons). The heating elements 4110 of the heating zones 8 and 9 are therefore completely deactivated (and also switched off), which is designated in FIG. 10c by the reference numeral 76.

The arrow P3 here illustrates a possible setting of the heating powers of the heating elements 4110 of the heater box illustrated in FIG. 10a, in which no bottom heating element 4115 is provided, and (currently) also no heating element 4110 is switched on. Since the lowest two heating elements are arranged below the base element 4113 or below the position S3 of the base element 4113 relative to the longitudinal direction of the plastic parisons, they are both deactivated and, in this state, characterised by black filled squares 78 they cannot be switched on (by an operator).

The arrow P4 illustrates a possible setting of the heating powers of the heating elements 4110 of a heater box illustrated in FIG. 10b, in which no bottom heating element 4115 is provided, and this is designated by a symbol 74 “T”, and (currently) also no heating element 4110 is switched on. Here a heating element 4110, the lowest heating element, is located below the position S2 of the reflector element 4113 and two further below the position S1 of the bottom heating element 4115. Thus, the heating elements 4110 of the heating zones 6 and 7 are below the top radiator or the bottom heating element 4115 and are therefore likewise deactivated, which is designated by the symbol 78. The bottom heating elements 4115 can always be used independently of the bottom tile position or the position of the reflector element 4113, i.e. they can always be activated and can always be switched on or off.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

### LIST OF REFERENCES

1 blow molding machine
2 container
3 parison
10, 20, 30 transport devices
40 heating device
41 first heating section
411, 412, 413, 414, 415, 416, 417 heating modules of the first heating section
4110 further heating elements
4111 counterpart reflector
4112 back reflector
4113, 4123, 4133 reflector elements of the heating modules 411, 412, 413
4115 bottom heating element
4115A, 4115B positions A and B of the bottom heating element
4116 electrical contact
4117 cable guide
4118 electrical cable
42 second heating section
421, 422, 423, 424, 425, 426, 427 heating modules of the second heating section
4213, 4223, 4233 reflector elements of the heating modules 421, 422, 423
43 redirection region
50 adjustment device
51, 52 rods
53 belt
54 driving device
60 operating device
62 arrangement of the heater boxes
64 heating power of the respective heating zone
70, 72, 74, 78 operating elements
80 bottom reflector detection device
90 parison length detection device
B bottom portion
L longitudinal direction of the parisons
P1, P2, P3, P4 arrows
TR1, TR2 transport directions

1. A machine for heating plastic parisons, comprising a transport device which transports the plastic parisons along a predetermined transport path, a heating device which heats the plastic parisons at least intermittently, wherein the heating device comprises at least:
a bottom heating element which is suitable and intended for heating a bottom portion of the plastic parisons,
a reflector element which is installed below the bottom portion of the plastic parisons the longitudinal direction of the plastic parisons and reflects thermal radiation onto the plastic parisons,
an adjusting device which is suitable and intended for adjusting the reflector element the longitudinal direction of the plastic parisons,
characterised in that the bottom heating element is arranged on the reflector element and/or is adjustable jointly therewith.

2. The machine according to claim 1, wherein bottom heating element is configured as a radiator element.

3. The machine according to claim 1, wherein the bottom heating element can be arranged with a defined spacing on the reflector element or recessed with a defined depth into the reflector element.

4. The machine according to claim 1, wherein heating device has further heating elements which are arranged one above the other in the longitudinal direction of the plastic parisons.

5. The machine according to claim 1, wherein an electrical contact of the bottom heating element is configured separately from the electrical contact of the other heating elements.

6. The machine according to claim 5, wherein an electrical contact of the bottom heating element extends below the reflector element and/or the bottom heating element.

7. The machine according to claim 6, wherein the machine can also be operated with the bottom heating element switched off.

8. The machine according to claim 6, wherein thermal radiation of the heating device is infrared radiation.

9. The machine according to claim 6, wherein thermal radiation is reflected by the reflector element onto the bottom portion of the plastic parisons.

10. The machine for heating plastic parisons, comprising a transport device which transports the plastic parisons along a predetermined transport path, a heating device which heats the plastic parisons at least intermittently, wherein the heating device comprises at least:
a reflector element which is installed below the bottom portion of the plastic parisons in the longitudinal direction of the plastic parisons and reflects thermal radiation onto the plastic parisons,
an adjusting device which is suitable and intended for adjusting the reflector element in the longitudinal direction of the plastic parisons,
at least one heating element and preferably a plurality of heating elements which are arranged one above the another in the longitudinal direction of the plastic parisons,
wherein the machine has a control device which is suitable and intended in order, as a function of the position of the reflector element, with respect to the longitudinal direction of the plastic parisons, to switch on at least one heating element automatically and/or to switch it off automatically.

11. The machine according to claim 10, wherein the control device is suitable and intended to automatically switch on and/or switch off at least one heating element which is arranged below the reflector element in relation to the longitudinal direction of the plastic parisons.

12. The machine according to claim 11, wherein the heating device has at least one bottom heating element which is arranged on the reflector element and which is suitable and intended to heat a bottom portion of the plastic parisons, and the control device is suitable and intended to automatically switch on and/or switch off at least one heating element as a function of the position of the bottom heating element with respect to the longitudinal direction of the plastic parisons.

13. The machine according to claim 12, wherein the control device automatically switches on and/or switches off at least one heating element in response to a signal transmitted by the adjustment device.

14. The machine according to claim 13, wherein the machine has a sensor device for detecting a position of the reflector element and/or a position of the bottom heating element, and the control device automatically switches at least one heating element on and/or off as a function of a position detected by the sensor device.

15. A method for heating plastic parisons, wherein the plastic parisons are transported by a transport device along a predetermined transport path and are heated at least intermittently by a heating device, wherein the bottom portion of the plastic parisons is at least also heated by a bottom heating element and wherein a reflector element, which is installed below the bottom portion of the plastic parisons in the longitudinal direction of the plastic parisons, reflects thermal radiation onto the plastic parisons, wherein the reflector element can be adjusted in the longitudinal direction of the plastic parisons by an adjusting device, wherein the bottom heating element is arranged on the reflector element and/or can be adjusted jointly therewith.
